(19) United States
(12) Patent Application Publication
(10) Pub. No.: US 2003/0112346 A1
(43) Pub. Date: Jun. 19, 2003

(54) Digital image processing

(75) Inventors: Timothy S. Owlett, Godalming (GB); Karl J. Wood, Crawley (GB)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/317,569

(22) Filed: Dec. 12, 2002

(30) Foreign Application Priority Data
Dec. 18, 2001 (GB) 0130174.6

(51) Int. Cl. H04N 5/76

(52) U.S. Cl. 348/231.6

(57) ABSTRACT

A digital camera has a microprocessor, which has installed therein an encryption algorithm. The algorithm has associated with it, a unique camera identification number (UCIN), the UCIN being recognisable by a remotely held decryption key. The decryption key is typically held by an authorised image processor who, on receipt of the camera, decrypts the images and publishes, distributes or prints the decrypted images as instructed by the camera owner. After the images have been processed, the authorised image processor may update the encryption algorithm and return the camera to the owner for re-use typically the camera will be provided at very low cost and a charge made to the owner for each image processing order made.

This invention relates to a novel method and apparatus for digital image processing. In particular, the invention provides for a customer's digital camera to be sent for processing with an authorised image processor and returned to the customer ready for re-use.

It is known from US 2001/0010543 A1 to provide a digital camera with a communications interface to enable the easy transmission of a user's images to, for example, an Internet service provider or a digital photo-finishing centre. The communications interface is provided through a network configuration file which can be downloaded to a memory card in the digital camera from a host computer. The network configuration file contains instruction information for communicating with a selected destination. The camera is provided with a send button which uses the configuration file to automatically send all information necessary for the reproduction of the image to the selected recipients

It is known from US2001/0012066 A1 to provide a digital stills camera with a re-usable memory card. The cameras are provided with a software application to be run on a user's PC which enables the user to manipulate images stored on the memory card and add address information for intended recipients of the images (for example service providers, image processors or e-mail addresses) and where appropriate billing/account information. This data can then be downloaded back to the memory card. The memory card can then be sent to a print service provider, or can be inserted in a print service kiosk along with a credit card (to effect payment). The print service kiosk then provides printed images on a “while-you-wait” basis.

One disadvantage of the aforementioned prior art systems is the need for the user to have access to a computer system in order to enable him to process or print his image.

An object of the present invention is to provide a camera and processing system whereby a user can enjoy the advantages of digital photography to provide better quality photo images and obtain printing or publishing of his images without the need to interface with a PC.

According to the invention there is provided a method for processing images recorded by a digital camera comprising;

downloading encrypted images from a camera;

decrypting the encrypted images; and

processing the images.

The images may be processed in a variety of ways including publishing to a given web site, e-mailing to a given e-mail address, printing or storing for future access by camera owner or image processor.

According to another aspect, the invention provides a digital camera having a microprocessor, the microprocessor having installed therein an encryption algorithm, the algorithm having associated therewith a unique camera identification number (UCIN), the UCIN being recognisable by a remotely held decryption key.

Typically, the encryption algorithm includes a public/private key pair. A code for accessing the public key (such as the UCIN) is provided with the camera. The private key is made available only to an authorised service provider. On receipt of a digital camera according to the invention, an authorised service provider locates the private key associated with the UCIN and decrypts the encrypted images. The images can then be published, printed and/or mailed as instructed by the camera owner. Optionally, the encryption algorithm installed on the microprocessor may be updated or changed and the camera returned to the user for re-use. Alternatively, the camera may be disposed of and a new camera purchased when required.

An advantage of the proposed method and apparatus is the ability for authorised service providers (who may be the distributors of the cameras) to ensure customers return to them for future image processing needs. A camera may be provided initially at low cost and the manufacturing costs recouped over time through charges made for image processing. Alternatively, the camera supplier and the authorised service provider will be separate business entities the latter, for example, paying a fee to the former for every image or set of images processed from one of the former's cameras, or, alternatively paying a fee to purchase the private keys needed for decrypting the encrypted images stored on the former's cameras.

An advantage to the user is that the loss of a low cost and easily replaceable camera is less to bear than that of a high specification digital camera as is known from the prior art.

In addition to the encryption algorithm, the microprocessor may be configured to run programs permitting manipulation of images, for example, digital zoom, image deletion and the like. More complex applications may be enabled such as addition of text to an image or the incorporation of decorative borders about an image. Such manipulation could be carried out by the user prior to encryption of the image. Desirably, therefore, encryption will only be effected when a user instructs the microprocessor of the camera to store an image.

The camera or the microprocessor is provided with plug or digital protocol which will communicate with decryption apparatus held by an authorised service provider. Desirably, the plug or digital protocol will be proprietary to the authorised service provider, this will further ensure that unauthorised persons are not able to process the images stored in the cameras.

According to a further aspect, the invention provides an image processing apparatus for a camera of the invention, the processing apparatus comprising;

means for communicating with the microprocessor of the camera;

means for locating a decryption key associated with the UCIN and thereby decrypting the encrypted images; and

means for downloading the images for storage and/or processing.

As previously discussed, the means for communicating may comprise a plug and socket arrangement and/or a digital protocol linking the processing apparatus with the microprocessor. The means for downloading may be one and the same as the means for communicating. The means for locating the decryption key may be suitably configured recognition software provided by the camera supplier with the decryption codes.

For the purposes of exemplification embodiments of the invention will now be further described with reference to the Figures in which:—

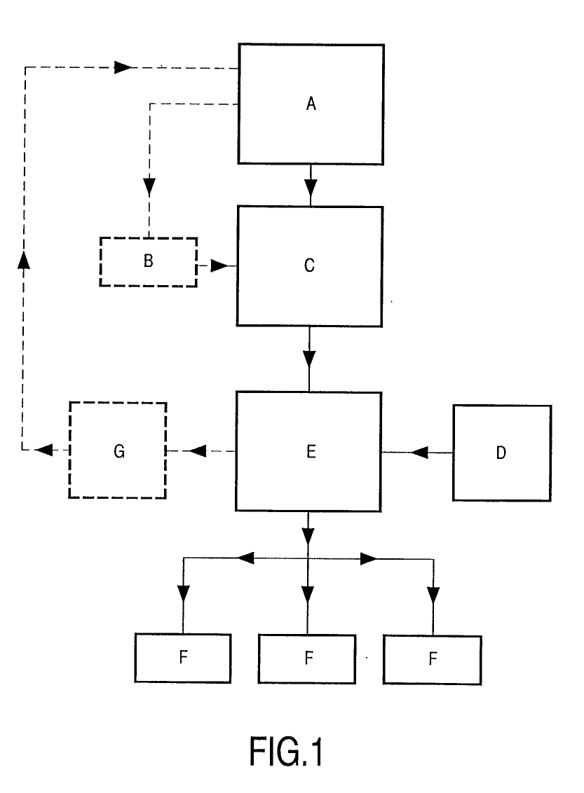

FIG. 1 shows schematically the life of an image recorded by a camera in accordance with the invention and processed according to the method of the invention.

In FIG. 1, Box A represents the capture of an image by a camera in accordance with the invention. Box B represents the optional step of manipulating the image before storing and encrypting as represented by Box C. Box D represents the step of locating the private key associated with a public key of a public/private pair used to encrypt the image in step C. Box E represents the decryption of the images for further processing. The 3 boxes marked F represent the completion of various forms of processing applied to the decrypted image, for example, printing, e-mailing to intended recipients and publishing to an intended web-site. Box G represents the optional step carried out by the service provider of updating or changing the encryption algorithm so that the camera can be re-used.

1. A method for processing images recorded by a digital camera comprising;
i) downloading encrypted images from a camera;
ii) decrypting the encrypted images; and
iii) processing the images.

2. A method for processing as claimed in claim 1, wherein step ii) involves identifying a private key associated with a public key of an encryption algorithm used to encrypt the images.

3. A method as claimed in claim 2, wherein the public key has associated therewith a unique camera identification number (UCIN) which in turn is used to identify the private key.

4. A method as claimed in claim 1, wherein step iii) involves publishing images on a web-site, electronically mailing images to one or more given addressees and/or printing the images for return to the camera owner.

5. A method as claimed in claim 1, and further comprising updating or changing the encryption algorithm used by the microprocessor of the camera to encrypt the images and providing the camera for re-use.

6. A digital camera having a microprocessor, the microprocessor having installed therein an encryption algorithm, the algorithm having associated therewith a unique camera identification number (UCIN), the UCIN being recognisable by a remotely held decryption key.

7. A digital camera as claimed in claim 6, wherein the microprocessor is configured to run programs permitting manipulation of the images prior to encryption.

8. A digital camera as claimed in claim 6, wherein the microprocessor is provided with plug or digital protocol configured to communicate with a decryption apparatus held by an authorised service provider.

9. A digital camera as claimed in claim 8, wherein the plug or digital protocol is proprietary and/or unique to the authorised service provider.

10. An image processing apparatus for a camera as claimed in any of claims 6 to 9, the processing apparatus comprising;
means for communicating with the microprocessor of the camera;
means for locating a decryption key associated with the UCIN and thereby decrypting the encrypted images; and
means for downloading the images for storage and/or processing.

11. An image processing apparatus as claimed in claim 10, wherein the means for communicating comprises a plug and socket arrangement and/or a digital protocol linking the processing apparatus with the microprocessor.

12. An image processing apparatus as claimed in claim 11, wherein the means for communicating is also the means for downloading.
